(19) United States
(12) Patent Application Publication
(10) Pub. No.: US 2012/0225994 A1
(43) Pub. Date: Sep. 6, 2012

(54) PROPYLENE RESIN COMPOSITION

(75) Inventor: Shinichi KONDO, Ichihara-shi (JP)

(73) Assignee: SUMITOMO CHEMICAL COMPANY, LIMITED, Tokyo (JP)

(21) Appl. No.: 13/404,208

(22) Filed: Feb. 24, 2012

(30) Foreign Application Priority Data
Mar. 2, 2011 (JP) 2011-044919

(51) Int. Cl. C08L 23/26; C08L 23/36

(52) U.S. Cl. 524/528

(57) ABSTRACT

Disclosed is a propylene resin composition from which a molded article maintaining mechanical properties of conventional molded articles and being superior in scratch can be produced, the composition including from 60% by mass to 99% by mass of a propylene resin (A), from 1% by mass to 40% by mass of a filler (B1) having a pH of from 9 to 14, and from 0.01 parts by mass to 5 parts by mass, relative to 100 parts by mass of the (A) and the (B1) in total, of a modified olefin resin (C1) obtained by reacting an olefin resin, an acidic compound having at least one unsaturated bond and at least one kind of polar group and having a pH of higher than 0 and up to 4, and an organic peroxide.

### BACKGROUND OF THE INVENTION

1. Technical Field

The present invention relates to propylene resin compositions.

2. Background Art

It is known to adjust mechanical properties desirably by adding an ethylene-α-olefin copolymer, an inorganic filler, and the like to a propylene resin.

For example, patent document 1 discloses a resin composition comprising prescribed amounts of polypropylene, polyethylene, an ethylene-α-olefin copolymer elastomer or a styrenic elastomer, and an inorganic filler.

In addition, patent document 2 discloses a resin composition comprising prescribed amounts of polypropylene, talc, an olefin-based elastomer, and an amide compound.

### RELATED ART DOCUMENTS

[Patent Document 1] JP 2002-3692 A

[Patent Document 2] JP 2006-83251 A

### SUMMARY OF THE INVENTION

However, many of the inorganic fillers contained in the resin compositions disclosed in these documents are neutral fillers, which have weak interaction between polypropylene and such a filler, and interface strength with polypropylene is weak. Therefore, there was a problem that the scratch resistance of a molded article obtained by molding a resin composition becomes low.

In light of the above-described problem, the object of the present invention is to provide a propylene resin composition from which a molded article maintaining mechanical properties of conventional molded articles and being superior in scratch can be produced.

The present invention provides a propylene resin composition comprising from 60% by mass to 99% by mass of a propylene resin (A), from 1% by mass to 40% by mass of a filler (B1) having a pH of from 9 to 14, where the sum total of the contents of the (A) and the (B1) shall be 100% by mass, and from 0.01 parts by mass to 5 parts by mass, relative to 100 parts by mass of the (A) and the (B1) in total, of a modified olefin resin (C1) defined below:

the modified olefin resin (C1) is a resin obtained by reacting 100 parts by mass of an olefin resin, from 0.01 parts by mass to 20 parts by mass, relative to 100 parts by mass of the olefin resin, of an acidic compound having at least one unsaturated bond and at least one kind of polar group and having a pH of higher than 0 and up to 4, and from 0.001 parts by mass to 20 parts by mass of an organic peroxide.

Further, the present invention provides a propylene resin composition comprising from 60% by mass to 99% by mass of a propylene resin (A), from 1% by mass to 40% by mass of a filler (B2) having a pH of higher than 0 and up to 4, where the sum total of the contents of the (A) and the (B2) shall be 100% by mass, and from 0.01 parts by mass to 5 parts by mass, relative to 100 parts by mass of the (A) and the (B2) in total, of a modified olefin resin (C2) defined below:

the modified olefin resin (C2) is a resin obtained by reacting 100 parts by mass of an olefin resin, from 0.01 parts by mass to 20 parts by mass, relative to 100 parts by mass of the olefin resin, of an acidic compound having at least one unsaturated bond and at least one kind of polar group and having a pH of from 9 to 14, and from 0.001 parts by mass to 20 parts by mass of an organic peroxide.

In the present invention, the pH of a filler, the pH of an acidic compound, and the pH of a basic compound each mean a pH measured by the following procedures. First, in a container, 20 ml of methanol is added to 5.0 g of a substance to be measured (i.e., a filler, a acidic compound, or a basic compound), followed by stirring with a glass rod, and then 100 ml of pure water is added. Then, the container is placed in a water bath of from 60° C. to 70° C. for 30 minutes. Thereafter, the container is removed from the water bath and is allowed to cool to ambient temperature. The cooled mixture is filtered and the pH of the resulting filtrate is measure by a glass electrode method by using a pH meter. The thus-measured pH is considered to be the pH of the substance to be measured.

According to the present invention, it is possible to provide a propylene resin composition from which a molded article maintaining mechanical properties of conventional molded articles and being superior in scratch can be produced.

### DESCRIPTION OF THE PREFERRED EMBODIMENTS

The propylene resin composition according to the present invention (henceforth a resin composition) comprises a propylene resin (A), the aforementioned filler (B1) or filler (B2), and the aforementioned modified olefin resin (C1) or modified olefin resin (C2).

### [Component (A): Propylene Resin (A)]

The propylene resin (A) in the present invention refers to a propylene homopolymer or a copolymer of propylene with other monomers. These may be used singly or alternatively two or more of them may be blended for use. The aforementioned copolymer may be either a random copolymer or a block copolymer.

Examples of the random copolymer include a random copolymer composed of constitutional units derived from propylene and constitutional units derived from ethylene; a random copolymer composed of constitutional units derived from propylene and constitutional units derived from an α-olefin other than propylene; and a random copolymer composed of constitutional units derived from propylene, constitutional units derived from ethylene, and constitutional units derived from an α-olefin other than propylene.

Examples of the block copolymer include a polymeric material composed of a propylene homopolymer component or a polymer component composed mainly of constitutional units derived from propylene (hereinafter referred to as polymer component (I)) and a copolymer component of propylene with one or more comonomers selected from among ethylene and α-olefins (hereinafter referred to as polymer component (II)).

From the viewpoint of the balance between the tensile strength and the impact resistance of the resin composition, the isotactic pentad fraction measured by ¹³C-NMR of the propylene resin (A) is preferably 0.97 or more and more preferably 0.98 or more. The isotactic pentad fraction is a value determined by the measurement method described later and it is a measure which indicates that the closer to 1 the isotactic pentad fraction of a propylene resin (A) is, the higher the regioregularity of the molecular structure of the propylene resin (A) is.

When the propylene resin (A) is a random copolymer like that mentioned above or a block copolymer like that mentioned above, the value measured for the propylene units in the copolymer is used as the isotactic pentad fraction of the propylene resin (A).

The melt flow rate (hereinafter abbreviated as MFR) of the propylene copolymer (A) measured at 230° C. under a load of 2.16 kgf in accordance with JIS-K-7210 is preferably from 0.5 g/10 minutes to 200 g/10 minutes, more preferably from 1 g/10 minutes to 100 g/10 minutes, even more preferably from 2 g/10 minutes to 80 g/10 minutes, and most preferably from 5 g/10 minutes to 50 g/10 minutes from the viewpoints of the elongation at break and impact strength of a molded article to be obtained.

The propylene resin (A) can be produced by a method described below using a conventional polymerization catalyst.

Examples of the polymerization catalyst include Ziegler type catalyst systems, Ziegler-Natta type catalyst systems, catalyst systems composed of an alkyl aluminoxane and'a compound of a transition metal of Group 4 of the periodic table which compound has a cyclopentadienyl ring, catalyst systems composed of an organoaluminum compound, a compound of a transition metal of Group 4 of the periodic table which compound has a cyclopentadienyl ring, and a compound capable of reacting with the compound of the transition metal to form an ionic complex, and catalyst systems prepared by modifying catalyst components such as a compound of a transition metal of Group 4 of the periodic table which compound has a cyclopentadienyl ring, a compound capable of forming an ionic complex, and an organoaluminum compound by supporting them on inorganic particles such as silica and clay mineral; preliminarily polymerized catalysts which are prepared by preliminarily polymerizing ethylene or an α-olefin in the presence of the aforementioned catalyst systems may also be used.

Specific examples of the catalyst systems include the catalyst systems disclosed in JP 61-218606 A, JP 5-194685 A, JP 7-216017 A, JP 9-316147 A, JP 10-212319 A, and JP 2004-182981 A.

Examples of the polymerization method include bulk polymerization, solution polymerization, slurry polymerization, and vapor phase polymerization. The bulk polymerization is a method in which polymerization is carried out using, as a medium, an olefin that is liquid at the polymerization temperature, and the solution polymerization or the slurry polymerization is a method in which polymerization is carried out in an inert hydrocarbon solvent such as propane, butane, isobutane, pentane, hexane, heptane, and octane. The gas phase polymerization is a method in which a gaseous monomer is used as a medium and a gaseous monomer is polymerized in the medium.

Such polymerization methods may be conducted either in a batch system or in a continuous system and also may be conducted either in a single stage system using one polymerization reactor or in a multistage system using a polymerization apparatus composed of a plurality of polymerization reactors linked in series and these polymerization methods may be combined appropriately. From the industrial and economical point of view, a continuous vapor phase polymerization method or a bulk-vapor phase polymerization method in which a bulk polymerization method and a vapor phase polymerization method are used continuously is preferred.

The conditions of each polymerization step (polymerization temperature, polymerization pressure, monomer concentration, amount of catalyst to be charged, polymerization time, etc.) may be determined appropriately depending on the desired propylene resin (A).

In the production of the propylene resin (A), in order to remove a residual solvent contained in the propylene resin (A) or ultra-low molecular weight oligomers formed during the production, the propylene resin (A) may be dried at a temperature not higher temperature at which the propylene resin (A) melts. Examples of the drying method include those disclosed in JP 55-75410 A and JP 2565753.

### <Random Copolymer>

As described above, the random copolymer in the present invention includes a random copolymer composed of constitutional units derived from propylene and constitutional units derived from ethylene; a random copolymer composed of constitutional units derived from propylene and constitutional units derived from an α-olefin other than propylene; and a random copolymer composed of constitutional units derived from propylene, constitutional units derived from ethylene, and constitutional units derived from an α-olefin other than propylene.

The α-olefin other than propylene which constitutes the random copolymer is preferably an α-olefin having from 4 to 10 carbon atoms, examples of which include 1-butene, 1-pentene, 1-hexene, 4-methyl-1-heptene, 1-octene and 1-decene and are preferably 1-butene, 1-hexene or 1-octene.

Examples of the random copolymer composed of constitutional units derived from propylene and constitutional units derived from α-olefin include a propylene-1-butene random copolymer, a propylene-1-hexene random copolymer, propylene-1-octene random copolymer, and a propylene-1-decene random copolymer.

Examples of the random copolymer composed of constitutional units derived from propylene, constitutional units derived from ethylene, and constitutional units derived from an α-olefin other than propylene include a propylene-ethylene-1-butene random copolymer, a propylene-ethylene-1-hexene random copolymer, propylene-ethylene-1-octene random copolymer, and a propylene-ethylene-1-decene random copolymer.

The content of the constitutional units derived from one or more comonomers selected from among ethylene and α-olefins in the random copolymer is preferably from 0.1% by mass to 40% by mass, more preferably from 0.1% by mass to 30% by mass, and even more preferably from 2% by mass to 15% by mass. The content of the constitutional units derived from propylene is preferably from 60% by mass to 99.9% by mass, more preferably from 70% by mass to 99.9% by mass, and even more preferably from 85% by mass to 98% by mass.

### <Block Copolymer>

As described above, the block copolymer in the present invention is a polymeric material composed of a propylene homopolymer component or a polymer component composed mainly of constitutional units derived from propylene (hereinafter referred to as polymer component (I)) and a copolymer component of propylene with one or more comonomers selected from among ethylene and α-olefins (hereinafter referred to as polymer component (II)).

The polymer component (I) is a propylene homopolymer component or a polymer component composed mainly of constitutional units derived from propylene. The polymer component composed mainly of constitutional units derived from propylene is a propylene copolymer component composed of units derived from propylene and units derived from at least one comonomer selected from the group consisting of ethylene and α-olefins having from 4 to 10 carbon atoms.

When the polymer component (I) is a polymer component composed mainly of constitutional units derived from propylene, the content of the units derived from propylene is from 70% by mass to 99.99% by mass, and the content of the constitutional units derived from at least one comonomer selected from the group consisting of ethylene and α-olefins having from 4 to 10 carbon atoms is from 0.01% by mass to 30% by mass, where the mass of the polymer component (I) shall be 100% by weight.

1-Butene, 1-hexene, and 1-octene are preferred as the α-olefin having from 4 to 10 carbon atoms and 1-butene is more preferred.

Examples of the polymer component composed of constitutional units derived from propylene include a propylene-ethylene copolymer component, a propylene-1-butene copolymer component, a propylene-1-hexene copolymer component, a propylene-1-octene copolymer component, a propylene-ethylene-1-butene copolymer component, a propylene-ethylene-1-hexene copolymer component, and a propylene-ethylene-1-octene copolymer component.

Examples of the polymer component (I) preferably include a propylene homopolymer component, a propylene-ethylene copolymer component, a propylene-1-butene copolymer component, and a propylene-ethylene-1-butene copolymer component.

The polymer component (II) is a copolymer component composed of constitutional units derived from at least one comonomer selected from the group consisting of ethylene and α-olefins having from 4 to 10 carbon atoms and constitutional units derived from propylene.

The content of the constitutional units derived from at least one comonomer selected from the group consisting of ethylene and α-olefins having from 4 to 10 carbon atoms contained in the polymer component (II) is from 1% by mass to 80% by mass, preferably from 5% by mass to 60% by mass, and more preferably from 20% by mass to 60% by weight, where the mass of the polymer component (II) shall be 100% by weight.

Examples of the α-olefin having from 4 to 10 carbon atom that constitutes the polymer component (II) include α-olefins the same as the α-olefins having from 4 to 10 carbon atoms that constitute the aforementioned polymer component (I).

Examples of the polymer component (II) include a propylene-ethylene copolymer component, a propylene-ethylene-1-butene copolymer component, a propylene-ethylene-1-hexene copolymer component, a propylene-ethylene-1-octene copolymer component, a propylene-ethylene-1-decene copolymer component, a propylene-1-butene copolymer component, a propylene-1-hexene copolymer component, a propylene-1-octene copolymer component, and a propylene-1-decene copolymer component; a propylene-ethylene copolymer component, a propylene-1-butene copolymer component, and a propylene-ethylene-1-butene copolymer component are preferred and a propylene-ethylene copolymer component is more preferred.

The content of the polymer component (II) of the polymeric material composed of the polymer component (I) and the polymer component (II) is preferably from 1% by mass to 50% by mass, more preferably from 1% by mass 1 to 40% by mass, even more preferably from 10% by mass to 40% by mass, and most preferably from 10% by mass to 30% by mass, where the mass of the propylene resin (A) shall be 100% by mass.

When the polymer component (I) of the polymeric material composed of the polymer component (I) and the polymer component (II) is a propylene homopolymer component, examples of the propylene copolymer include a (propylene)-(propylene-ethylene) copolymer, a (propylene)-(propylene-ethylene-1-butene) copolymer, a (propylene)-(propylene-ethylene-1-hexene) copolymer, a (propylene)-(propylene-ethylene-1-octene) copolymer, a (propylene)-(propylene-1-butene) copolymer, a (propylene)-(propylene-1-hexene) copolymer, a (propylene)-(propylene-1-octene) copolymer, and a (propylene)-(propylene-1-decene) copolymer.

When the polymer component (I) of the polymeric material composed mainly of the polymer component (I) and the polymer component (II) is a propylene copolymer component composed of units derived from propylene, examples of the propylene copolymer composed of the polymer component (I) and the polymer component (II) include a (propylene-ethylene)-(propylene-ethylene) copolymer, (propylene-ethylene)-(propylene-ethylene-1-butene) copolymer, a (propylene-ethylene)-(propylene-ethylene-1-hexene) copolymer, a (propylene-ethylene)-(propylene-ethylene-1-octene) copolymer, a (propylene-ethylene)-(propylene-ethylene-1-decene) copolymer, a (propylene-ethylene)-(propylene-1-butene) copolymer, a (propylene-ethylene)-(propylene-1-hexene) copolymer, a (propylene-ethylene)-(propylene-1-octene) copolymer, a (propylene-ethylene)-(propylene-1-decene) copolymer, a (propylene-1-butene)-(propylene-ethylene) copolymer, a (propylene-1-butene)-(propylene-ethylene-1-butene) copolymer, a (propylene-1-butene)-(propylene-ethylene-1-hexene) copolymer, a (propylene-1-butene)-(propylene-ethylene-1-octene) copolymer, a (propylene-1-butene)-(propylene-ethylene-1-decene) copolymer, a (propylene-1-butene)-(propylene-1-butene) copolymer, a (propylene-1-butene)-(propylene-1-hexene) copolymer, a (propylene-1-butene)-(propylene-1-octene) copolymer, a (propylene-1-butene)-(propylene-1-decene) copolymer, a (propylene-1-hexene)-(propylene-1-hexene) copolymer, a (propylene-1-hexene)-(propylene-1-octene) copolymer, a (propylene-1-hexene)-(propylene-1-decene) copolymer, a (propylene-1-octene)-(propylene-1-octene) copolymer, and a (propylene-1-octene)-(propylene-1-decene) copolymer.

Preferred examples of the polymeric material composed of the polymer component (I) and the polymer component (II) include a (propylene)-(propylene-ethylene) copolymer, a (propylene)-(propylene-ethylene-1-butene) copolymer, a (propylene-ethylene)-(propylene-ethylene) copolymer, a (propylene-ethylene)-(propylene-ethylene-1-butene) copolymer, and a (propylene-1-butene)-(propylene-1-butene) copolymer; a (propylene)-(propylene-ethylene) copolymer is more preferred.

The intrinsic viscosity of the polymer component (I) measured in 135° C. tetralin ([η]I) is preferably from 0.1 dl/g to 5 dl/g, more preferably from 0.3 dl/g to 4 dl/g, and even more preferably from 0.5 dl/g to 3 dl/g.

The intrinsic viscosity of the polymer component (II) measured in 135° C. tetralin ([η]II) is preferably from 1 dl/g to 20 dl/g, more preferably from 1 dl/g to 10 dl/g, and even more preferably from 2 dl/g to 7 dl/g.

The ratio of the intrinsic viscosity of the polymer component (II) ([η]II) to the intrinsic viscosity of the polymer component (I) ([η]I) is preferably from 1 to 20, more preferably from 2 to 10, and even more preferably from 2 to 9.

The intrinsic viscosity (unit: dl/g) in the present invention is a value measured by the method described below at a temperature of 135° C. using tetralin as a solvent.

Reduced viscosities are measured at three concentrations of 0.1 dl/g, 0.2 dl/g and 0.5 dl/g by using a Ubbelohde's viscometer. The intrinsic viscosity is calculated by the calculation method described in “Kobunshi Yoeki (Polymer Solution), Kobunshi Jikkengaku (Polymer Experiment Study) Vol. 11” page 491 (published by Kyoritsu Shuppan Co., Ltd., 1982), namely, by an extrapolation method in which reduced viscosities are plotted against concentrations and the concentration is extrapolated to zero.

When the propylene resin (A) is a polymeric material to be obtained by producing the polymer component (I) and the polymer component (II) by multistage polymerization, the intrinsic viscosity of the polymer component (I) or the polymer component (II) produced in the polymerization vessel of the earlier stage is determined using a polymer powder extracted from the polymerization vessel and then the intrinsic viscosity of the component produced in the polymerization stage of the later stage is calculated from the value of the previously determined intrinsic viscosity and the contents of the respective components in the polymeric material finally obtained.

Moreover, when the polymeric material composed of the polymer component (I) and the polymer component (II) is a polymeric material such that the polymer component (I) is obtained by the polymerization step of the earlier stage and the polymer component (II) is obtained in the latter step, the procedures of the measurement and the calculation of the contents of the polymer component (I) and the polymer component (II) and the intrinsic viscosities ([η]Total, [η]I, [η]II) are as follows. The intrinsic viscosity ([η]Total) represents the intrinsic viscosity of the whole propylene resin (A).

From the intrinsic viscosity of the polymer component (I) obtained by the polymerization step of the earlier stage ([η]I), the intrinsic viscosity of the last polymer after the polymerization step of the latter stage (component (I) and component (II)) measured by the above-described method ([η]Total), and the content of the polymer component (II) contained in the final polymer, the intrinsic viscosity of the polymer component (II) [η]II is calculated from the following formula:

[η]II=([η]Total−[η]I×XI)/XII

[η]Total: the intrinsic viscosity (dl/g) of the final polymer after the polymerization step of the latter stage

[η]I: the intrinsic viscosity (dl/g) of a polymer powder extracted from a polymerization reactor after the polymerization step of the earlier stage

XI: the mass ratio of polymer component (I) to the whole propylene resin (A)

XII: the mass ratio of polymer component (II) to the whole propylene resin (A)

XI and XII are calculated from the mass balance in the polymerizations.

The block copolymer is obtained by producing the polymer component (I) in the first step and then producing the polymer component (II) in the second step. The polymerization is carried our using the above-described polymerization catalyst.

The content of the propylene resin (A) is from 60% by mass to 99% by mass, and preferably from 65% by mass to 80% by mass 80, where the sum total of the component (A) and the component (B1) or component (B2) shall be 100% by mass. If it is more than 99% by mass, the rigidity or the impact resistance of a molded article may deteriorate, whereas if it is less than 60% by mass, the scratch resistance of a molded article may deteriorate.

### [Component (B): Filler (B)]

The filler to be used in the present invention is a filler (B1) having a pH of from 9 to 14 or a filler (B2) having a pH of higher than 0 and up to 4. The filler (B1) is used in combination with the modified olefin resin (C1) and the filler (B2) is used in combination with the modified olefin resin (C2).

In the present invention, the filler (B1) and the filler (B2) are written collectively as filler (B).

<Filler (B1) Having a pH of from 9 to 14>

Examples of the filler (B1) having a pH of from 9 to 14 include basic aluminum hydroxide, alkaline silicic acids, basic magnesium sulfate, basic wollastonite, and inorganic fillers surface-treated with basic substances. Among these, basic magnesium sulfate and basic wollastonite are preferred, and basic wollastonite is even more preferred.

The range of the pH of the filler (B1) is from 9 to 14 and preferably from 10 to 14. If the pH is less than 9, then the adhesiveness to a modified olefin copolymer (C1) will deteriorate and the scratch resistance will deteriorate.

The average particle diameter of the filler (B1) is preferably 10 μm or less, and more preferably 5 μm or less. The “average particle diameter” in the present invention means a 50% equivalent particle diameter D50 that is determined from an integral distribution curve of the sub-sieve method produced through measurement conducted with fillers being suspended in a dispersing medium, such as water and alcohol, by means of a centrifugal sedimentation type particle size distribution analyzer.

The filler (B1) may be used in any form, such as a powdered form, a flaked form, and a granular form.

The content of the filler (B1) is from 1% by mass to 40% by mass, and preferably from 2% by mass to 10% by mass, where the sum total of (A) and (B1) shall be 100% by mass. If the content is more than 40% by mass, the impact resistance of a molded article may deteriorate, whereas if it is less than 1% by mass, the rigidity may deteriorate.

<Filler (B2) Having a pH of Higher than 0 and Up to 4>

Examples of the filler (B2) having a pH of higher than 0 and up to 4 include kaolin clay, acidic silica, and inorganic fillers surface-treated with acidic substances.

The range of the pH of the filler (B2) is higher than 0 and up to 4. If the pH is higher than 4, then the adhesiveness to a modified olefin copolymer (C2) will deteriorate and the scratch resistance will deteriorate.

The average particle diameter of the filler (B2) is preferably 10 μm or less and more preferably up to 5 μm.

The filler (B2) may be in a powdered form, a flaked form, a granular form, or the like and it may be in any form.

The content of the filler (B2) is from 1% by mass to 40% by mass, and preferably from 2% by mass to 10% by mass, where the sum total of (A) and (B2) shall be 100% by mass. If the content is more than 40% by mass, the impact resistance of a molded article may deteriorate, whereas if it is less than 1% by mass, the rigidity may deteriorate.

### [Component (C): Modified Olefin Resin (C)]

The modified olefin resin to be used in the present invention is a modified olefin resin (C1) or a modified olefin resin (C2). The modified olefin resin (C1) is used with the above-described filler (B1) in combination and the modified olefin resin (C2) is used with the filler (B2) in combination.

In the present invention, the modified olefin resin (C1) and the modified olefin resin (C2) are written collectively as modified olefin resin (C).

The content of the modified olefin resin (C) is from 0.01 parts by mass to 5 parts by mass, preferably from 0.1 parts by mass to 3 parts by mass, and more preferably from 0.3 parts by mass to 2 parts by mass, relative to 100 parts by mass of the component (A) and the component (B) total. If the content is less than 0.01 parts by mass, the scratch resistance of a molded article may deteriorate. Conversely, if the content exceeds 5 parts by mass, the rigidity and the impact resistance of a molded article may deteriorate.

### <Modified Olefin Resin (C1)>

The modified olefin resin (C1) is a resin obtainable by reacting 100 parts by mass of an olefin resin, from 0.01 parts by mass to 20 parts by mass of an acidic compound having at least one unsaturated bond and at least one kind of polar group and having a pH of higher than 0 and up to 4, and from 0.001 parts by mass to 20 parts by mass of an organic peroxide.

The olefin resin is not particularly restricted as far as it is one having a structural unit derived from an olefin and examples thereof include an ethylene resin, a propylene resin, a butene resin, and hydrogenated block copolymers. Among these, use of an ethylene resin or a propylene resin is preferred and use of a propylene resin is more preferred.

Examples of the ethylene resin include a high density polyethylene (HDPE), a low density polyethylene (ODPE), and a linear low density polyethylene (LLDPE). A commercial product may also be used. Examples thereof include ENGAGE (registered trademark) produced by The Dow Chemical Japan, Ltd., TAFMER (registered trademark) produced by Mitsui Chemicals, Inc., NEO-ZEX (registered trademark) and ULTZEX (registered trademark) produced by Prime Polymer Co., Ltd., and EXCELLEN FX (registered trademark), SUMIKATHENE (registered trademark), and ESPLENE SPO (registered trademark) produced by Sumitomo Chemical Co., Ltd.

Examples of the propylene resin include propylene resins the same as those of component (A).

The acidic compound having a pH of higher than 0 and up to 4 is a compound that has at least one unsaturated bond and at least one kind of polar group.

Examples of the unsaturated bond include a carbon-carbon double bond and a carbon-carbon triple bond. The polar group may be a group selected from the group consisting of a carboxyl group, an ester group, a sulfo group, a sulfino group, and a hydroxyl group. In the present invention, the aforementioned unsaturated bond does not include the unsaturated bond contained in the aforementioned polar group.

Specific examples of the acidic compound having a pH of higher than 0 and up to 4 include (meth)acrylic acid, maleic acid, maleic anhydride, itaconic acid, itaconic anhydride, fumaric acid, cinnamic acid, crotonic acid, vinylbenzoic acid, 2-methacryloxyethylsuccinic acid, 2-methacryloxyethylmaleic acid, 2-methacroyloxyethylhexahydrophthalic acid, vinylsulfonic acid, allylsulfonic acid, styrene sulfonic acid, 2-sulfoethyl methacrylate, 2-acrylamido-2-methylpropanesulfonic acid, 3-chloroamidophosphoxypropyl methacrylate, and 2-methacryloxyethyl acid phosphate. Among these, it is preferred to use at least one compound selected from the group consisting of maleic anhydride, maleic acid, and fumaric acid.

The organic peroxide is not particularly restricted as far as it is one that decomposes to generate a radical and then works to remove a proton from an olefin resin; from the viewpoint of improving the graft amount of the acidic compound having a pH of higher than 0 and up to 4 to the olefin resin and the viewpoint of preventing crosslinking or decomposition of the olefin resin, it is preferred to use an organic peroxide whose decomposition temperature at which the half-life thereof is 1 minute is from 50° C. to 210° C.

Examples of the organic peroxide whose decomposition temperature at which the half-life thereof is 1 minute is from 50° C. to 210° C. include diacyl peroxides, dialkyl peroxides, peroxy ketals, alkyl peresters, and percarbonates. Especially, diacyl peroxides, dialkyl peroxides, alkyl peresters, or percarbonates are preferred.

Specific examples of the organic peroxide whose decomposition temperature at which the half-life thereof is 1 minute is from 50° C. to 210° C. include dicetyl peroxydicarbonate, di-3-methoxybutyl peroxydicarbonate, bis(2-ethylhexyl) peroxydicarbonate, bis(4-tert-butyl cyclohexyl) peroxydicarbonate, diisopropyl peroxydicarbonate, tert-butylperoxyisopropyl carbonate, dimyristyl peroxycarbonate, 1,1,3,3-tetramethylbutyl neodecanoate, α-cumylperoxy neodecanoate, tert-butylperoxy neodecanoate, 1,1-bis(tert-butylperoxy)cyclohexane, 2,2-bis(4,4-di-tert-butylperoxycyclohexyl)propane, 1,1-bis(tert-butylperoxy)cyclododecane, tert-hexylperoxyisopropyl monocarbonate, tert-butylperoxy-3,5,5-trimethyl hexanoate, tert-butyl peroxylaurate, 2,5-dimethyl-2,5-di-(benzoylperoxy)hexane, tert-butyl peroxyacetate, 2,2-bis(tert-butylperoxy)butene, tert-butyl peroxybenzoate, n-butyl 4,4-bis(tert-butylperoxy)valerate, di-tert-butylperoxy isophthalate, dicumyl peroxide, α,α′-bis(tert-butylperoxy-m-isopropyl)benzene, 2,5-dimethyl-2,5-di-(tert-butylperoxy)hexane, 1,3-bis(tert-butylperoxyisopropyl)benzene, tert-butylcumyl peroxide, di-tert-butyl peroxide, p-menthane hydroperoxide, and 2,5-dimethyl-2,5-di(tert-butylperoxy)hexyne-3.

The modified olefin resin (C1) is obtained by reacting from 0.01 parts by mass to 20 parts by mass of an acidic compound having a pH of higher than 0 and up to 4 and from 0.001 parts by mass to 20 parts by mass of an organic peroxide to 100 parts by mass of the aforementioned olefin resin. The amount used of the acidic compound is preferably from 0.1 parts by mass to 10 parts by mass, and more preferably from 0.2 parts by mass to 1 part by mass. If the amount used of the acidic compound is less than 0.01 parts by mass, the scratch resistance may deteriorate. Conversely, if the amount used exceeds 20 parts by mass, the rigidity and the impact resistance may deteriorate.

The amount used of the organic peroxide is preferably from 0.01 parts by mass to 10 parts by mass, and more preferably from 0.05 parts by mass to 3 parts by mass.

If the amount used of the organic peroxide is less than 0.01 parts by mass, the amount modified of the olefin resin may be small, so that the scratch resistance of a molded article may deteriorate. Conversely, if the amount used exceeds 10 parts by mass, the olefin resin may be decomposed or be crosslinked.

Examples of the method for producing the modified olefin resin (C1) include the following methods.

[1]: a method in which an olefin resin, an acidic compound and an organic peroxide are melt kneaded.
[2]: a method in which an olefin resin, an acidic compound and an organic peroxide are dissolved in an organic solvent and then the resulting solution is heated.
[3]: a method in which an olefin resin, an acidic compound, and an organic peroxide is suspended in water and then the resulting suspension is heated.

Among these, it is preferred to use the above method [1]. Examples of a kneading machine to be used for the melt kneading include conventional devices such as a Banbury mixer, a plastomill, a Brabender plastograph, a single screw extruder, and a twin screw extruder. Especially, a single screw extruder or a twin screw extruder is preferred from the viewpoint that continuous production can be conducted and high productivity is achieved.

### <Modified Olefin Resin (C2)>

The modified olefin resin (C2) is a resin obtainable by reacting 100 parts by mass of an olefin resin, from 0.01 parts by mass to 20 parts by mass of a basic compound having at least one unsaturated bond and at least one kind of polar group and having a pH of from 9 to 14, and from 0.001 parts by mass to 20 parts by mass of an organic peroxide.

As the olefin resin and the organic peroxide, olefin resins and organic peroxides the same as those to be used for the above-described modified olefin resin (C1) can be used.

The basic compound having a pH of from 9 to 14 is a compound that has at least one unsaturated bond and at least one kind of polar group.

Examples of the unsaturated bond include a carbon-carbon double bond and a carbon-carbon triple bond. The polar group may be any at least one kind of group selected from the group consisting of amino groups (—NH₂, —NHR group, and —NRR′ group, wherein R and R′ are each an alkyl group or an allyl group), a pyridyl group, and a piperidyl group.

Specific examples of the basic compound having a pH of from 9 to 14 include N-methylaminoethyl (meth)acrylate, N-ethylaminoethyl (meth)acrylate, N,N-dimethylaminoethyl (meth)acrylate, quaternary ammonium salts of N,N-dimethylaminoethyl (meth)acrylate, N,N-diethylaminoethyl (meth)acrylate, N,N-dibutylaminoethyl acrylate, N-phenylaminoethyl methacrylate, N,N-diphenylaminoethyl methacrylate, aminostyrene, dimethylaminostyrene, N-methylaminoethylstyrene, dimethylaminoethoxystyrene, diphenylaminoethylstyrene, N-phenylaminoethylstyrene, 2-N-piperidylethyl (meth)acrylate, 2-vinylpyridine, 4-vinylpyridine, 2-vinyl-6-methylpyridine, and dimethylaminopropylacrylamide.

The modified olefin resin (C2) is obtained by reacting from 0.01 parts by mass to 20 parts by mass of a basic compound having a pH of from 9 to 14 and from 0.001 parts by mass to 20 parts by mass of an organic peroxide to 100 parts by mass of the aforementioned olefin resin. The amount used of the basic compound is preferably from 0.1 parts by mass to 10 parts by mass, and more preferably from 0.2 parts by mass to 1 part by mass. If the amount used of the basic compound is less than 0.01 parts by mass, the scratch resistance may deteriorate. Conversely, if the amount used exceeds 20 parts by mass, the rigidity and the impact resistance may deteriorate.

The amount used of the organic peroxide is preferably from 0.01 parts by mass to 10 parts by mass, and more preferably from 0.05 parts by mass to 3 parts by mass. If the amount used of the organic peroxide is less than 0.01 parts by mass, the amount modified of the olefin resin may be small, so that the scratch resistance of a molded article may deteriorate. Conversely, if the amount used exceeds 10 parts by mass, the olefin resin may be decomposed or be crosslinked.

Examples of the method for producing the modified olefin resin (C2) include the following methods.

[1]: a method in which an olefin resin, a basic compound and an organic peroxide are melt kneaded.
[2]: a method in which an olefin resin, a basic compound and an organic peroxide are dissolved in an organic solvent and then the resulting solution is heated.
[3]: a method in which an olefin resin, a basic compound, and an organic peroxide is suspended in water and then the resulting suspension is heated.

Among these, it is preferred to use the above method [1]. Examples of a kneading machine to be used for the melt kneading include conventional devices such as a Banbury mixer, a plastomill, a Brabender plastograph, a single screw extruder, and a twin screw extruder. Especially, a single screw extruder or a twin screw extruder is preferred from the viewpoint that continuous production can be conducted and high productivity is achieved.

[Component (D): Olefin-Based Elastomer and/or Vinyl Aromatic Compound-Containing Elastomer (D)]

In the present invention, the resin composition may contain an olefin-based elastomer and/or a vinyl aromatic compound-containing elastomer (D).

The olefin-based elastomer is a copolymer of ethylene with an α-olefin having from 4 to 20 carbon atoms, wherein the content of ethylene is 50% by mass or more.

Examples of the α-olefin having from 4 to 20 carbon atoms include 1-butene, isobutene, 1-pentene, 2-methyl-1-butene, 3-methyl-1-butene, 1-hexene, 2-methyl-1-pentene, 3-methyl-1-pentene, 4-methyl-1-pentene, 1-octene, 1-nonene, 1-decene, 1-undecene, and 1-dodecene. These may be used singly or two or more of them may be used in combination. 1-Butene, 1-hexene and 1-octene are preferred.

The density of the olefin-based elastomer measured in accordance with JIS-K-7112 is preferably from 0.85 g/cm³ to 0.885 g/cm³, more preferably from 0.85 g/cm³ to 0.88 g/cm³, and even more preferably from 0.855 g/cm³ to 0.875 g/cm³ from the viewpoint of melt weldability in secondarily processing a molded article to be obtained, the viewpoint of increasing the dispersibility to the propylene resin (A), and the viewpoint of producing a molded article with high impact strength at room temperature or low temperatures. From the viewpoint of increasing the impact strength of a molded article, the MFR at 190° C. of the olefin-based elastomer measured in accordance with JIS-K-6758 is preferably from 0.1 g/10 minutes to 30 g/10 minutes, and more preferably from 0.5 g/10 minutes to 20 g/10 minutes.

An example of the method of producing the olefin-based elastomer is a method of producing it using a polymerization catalyst. Examples of the polymerization catalyst include Ziegler-Natta catalysts comprising a vanadium compound, an organoaluminum compound and a halogenated ester compound, catalysts comprising a combination of an alumoxane or boron compound with a metallocene compound composed of a titanium, zirconium or hafnium atom coordinated with a group having at least one cyclopentadienyl anion skeleton, and so-called metallocene catalysts.

Examples of the polymerization method include a method in which ethylene is copolymerized with an α-olefin in an inert organic solvent like a hydrocarbon compound and a method in which copolymerization is conducted in ethylene and an α-olefin without using a solvent.

Examples of the vinyl aromatic compound-containing elastomer include a block copolymer composed of a vinyl aromatic compound polymer block and a conjugated diene-based polymer block, a block polymer in which double bonds of the conjugated diene portions of said block copolymer have been hydrogenated, and an elastomer obtainable by reacting an olefin-based copolymer elastomer and a vinyl aromatic compound. Among these, it is preferred to use a block polymer in which 80% or more of the double bonds of the conjugated portions of the block copolymer have been hydrogenated, and it is more preferred to use a block copolymer in which 85% or more of the double bonds have been hydrogenated. These may be used singly or two or more of them may be used in combination.

An example of the vinyl aromatic compound contained in the vinyl aromatic compound-containing elastomer is styrene.

Examples of the block copolymer composed of a vinyl aromatic compound polymer block and a conjugated diene-based polymer block include a styrene-ethylene-butene-styrene-based elastomer (SEBS), a styrene-ethylene-propylene-styrene-based elastomer (SEPS), a styrene-butadiene-based elastomer (SBR), a styrene-butadiene-styrene-based elastomer (SBS), and a styrene-isoprene-styrene-based elastomer (SIS).

The average content of vinyl aromatic compound monomer units contained in the vinyl aromatic compound-containing elastomer is preferably from 10% by mass to 20% by mass, and more preferably from 12% by mass to 19% by mass, where the whole amount of the vinyl aromatic compound-containing elastomer shall be 100% by mass.

The MFR at 230° C. of the vinyl aromatic compound-containing elastomer measured in accordance with JIS-K-6758 is preferably from 0.1 g/10 minutes to 15 g/10 minutes, and more preferably from 1 g/10 minutes to 13 g/10 minutes.

The molecular weight distribution of the vinyl aromatic compound-containing elastomer, which is a molecular weight distribution (Q value) calculated from a weight average molecular weight (Mw) and a number average molecular weight (Mn) measured by gel permeation chromatography (GPC), is preferably up to 2.5, and more preferably up to 2.3.

Examples of the method for producing of the vinyl aromatic compound-containing elastomer include a method in which a vinyl aromatic compound is bonded to an olefin-based copolymer elastomer or a conjugate diene elastomer by polymerization, reaction, or the like.

An elastomer obtained by reacting an olefin-based copolymer elastomer with a vinyl aromatic compound may be used as the component (D). Examples of the elastomer obtained by reacting an olefin-based copolymer elastomer with a vinyl aromatic compound include an elastomer to be obtained by reacting an olefin-based copolymer elastomer such as an ethylene-propylene-nonconjugateddieneelastomer (EPDM), with a vinyl aromatic compound such as styrene.

The content of the component (D) is preferably from 1 part by mass to 40 parts by mass relative to 100 parts by mass of the component (A) and the component (B) in total.

### [Component (E): Lubricant (E)]

In the present invention, the resin composition may contain a lubricant (E).

Examples of the lubricant (E) include silane compounds, polyolefin waxes, and fatty acid amides. Among these, it is preferred to use a fatty acid amide and it is more preferred to use a fatty acid amide having from 6 to 22 carbon atoms. Examples of the fatty acid amide include lauramide, stearamide, oleamide, behenamide, and erucamide.

The content of the component (E) is preferably from 0.01 parts by mass to 5 parts by mass, more preferably from 0.1 parts by mass to 1.0 part by mass, and even more preferably from 0.3 parts by mass to 0.5 parts by mass, relative to 100 parts by mass of the component (A) and the component (B) in total.

If the content is less than 0.01 parts by mass, the scratch resistance of a molded article may deteriorate. Conversely, if the content exceeds 1 part by mass, the appearance of a molded article may deteriorate due to bleeding.

### [Component (F): Other Additives (E)]

The polypropylene resin composition of the present invention may contain known additives. Examples of the additives include a neutralizer, an antioxidant, a UV absorber, an antistatic agent, an antiblocking agents, a processing aid, an organic peroxide, coloring agents (an inorganic pigment, an organic pigment, a pigment dispersant, etc.), a foaming agent, a foam nucleating agent, a plasticizer, a flame retardant, a crosslinking agent, a crosslinking aid, a brightening agent, an antibacterial agent, and a light diffusing agent. Such additives may be used singly or two or more of them may be used in combination.

The resin composition may contain an inorganic filler having a pH of higher than 4 and lower than 9. Examples of such an inorganic filler having a pH of higher than 4 and lower than 9 include talc, wollastonite, and mica. Such inorganic fillers may be used singly or two or more of them may be used in combination.

### [Production of a Resin Composition]

The resin composition according to the present invention is obtained by melt kneading the above-described raw material components at a temperature of 180° C. or higher, preferably from 180° C. to 300° C., more preferably from 180° C. to 250° C. For the melt kneading is used a Banbury mixer, a single screw extruder, a co-rotating twin screw extruder, or the like. Although the order of kneading the respective raw material components is not particularly limited, a method in which the respective components are kneaded at a time is preferred.

Examples of the shape of the resin composition include a strand shape, a sheet shape, a flat shape, and a pellet shape produced by cutting a strand. In order to mold the propylene resin composition of the present invention, a pellet shape having a length of from 1 mm to 50 mm is a shape preferred from the viewpoint of the production stability of a molded article to be obtained.

From the viewpoint of molding workability, the MFR (measured at 230° C. under a load of 2.16 kgf in accordance with JIS-K-7210) of the whole resin composition is from 0.1 g/10 minutes to 400 g/10 minutes, more preferably from 0.5 g/10 minutes to 300 g/10 minutes, and even more preferably from 1 g/10 minutes to 200 g/10 minutes. The MFR of the resin composition of the present invention can be adjusted to within such ranges by appropriately adjusting the molecular weights of the respective polymeric ingredients and the amounts of the ingredients to be mixed.

The molded article to be obtained by molding the resin composition according to the present invention is preferably an injection molded article produced by an injection molding method. The injection molding method includes normal injection molding, injection foam molding, supercritical injection foam molding, ultrahigh speed injection molding, injection compression molding, gas-assist injection molding, sandwich molding, sandwich foam molding and insert/outsert molding.

Examples of molded articles obtainable in such a way include automobile materials, household appliance materials, OA instrument materials, materials for medical applications, waste water pans, toiletry materials, bottles, containers, sheets, films, and construction materials.

### EXAMPLES

The present invention is described in more detail based on examples, but the invention is not limited to the examples. The components used in the examples and comparative examples are as follows.

### (1) Propylene Resin (A)

### (A-1): (Propylene)-(Propylene-Ethylene) Copolymer

(Propylene)-(propylene-ethylene) copolymer composed of a polymer component (I) and a polymer component (II)

This copolymer was produced by using a polymerization catalyst obtainable by the method described in Example 1 of JP 2004-182981 A, and by a liquid phase-gas phase polymerization process under such conditions that a propylene polymer with the following physical properties was obtainable.

MFR of the (propylene)-(propylene-ethylene) copolymer (at 230° C. under a load of 2.16 kgf): 30 g/10 minutes

Ethylene content of the (propylene)-(propylene-ethylene) copolymer: 5.1% by mass

Intrinsic viscosity of the (propylene)-(propylene-ethylene) copolymer ([η]Total): 1.52 dl/g

[η]II/[η]I=5.0

Polymer component (I): propylene homopolymer component

Intrinsic viscosity of polymer component (I) ([η]I): 1.00 dl/g

Polymer component (II): propylene-ethylene copolymer component

Content of polymer component (II): 13.0% by mass

Ethylene content of polymer component (II): 39.5% by mass

Intrinsic viscosity of polymer component (II)([η]II): 5.0 dl/g

### (A-2): Propylene Homopolymer

MFR: (at 230° C. under a load of 2.16 kgf): 120 g/10 minutes

Intrinsic viscosity ([η]): 0.92 dl/g

### (2) Inorganic Filler (B)

### (B-1) Basic Wollastonite

NYGLOS4W (registered trademark, produced by NYCO)

Average fiber diameter: 4.5 μm

pH: 10.3

### (B-2) Talc

JR-46 (registered trademark, produced by Hayashi Kasei Co., Ltd.)

Average particle diameter: 2.8 μm

pH: 8.1

### (B-3) Wollastonite

NYGLOS8 (registered trademark, produced by NYCO)

Average fiber diameter: 8 μm

pH: 8.3

### (B-4) Mica

A-41 (registered trademark, produced by Yamaguchi Mica Co., Ltd.)

Average particle diameter: 47 μm

pH: 7.0

### (3) Modified Olefin Resin (C1)

A product prepared by reacting the olefin resin, the acidic compound having a pH of higher than 0 and up to 4, and the organic peroxide, each described below, in the following procedure was used as a modified olefin resin.

As an olefin resin, the following (propylene)-(propylene-ethylene) copolymer composed of a polymer component (I) and a polymer component (II) was used. The (propylene)-(propylene-ethylene) copolymer is a product produced by using a polymerization catalyst obtainable by the method described in Example 1 of JP 2004-182981 A and by a liquid phase-gas phase polymerization process under such conditions that a propylene polymer with the following physical properties can be obtained.

MFR of the propylene-(propylene-ethylene) copolymer (at 230° C. under a load of 2.16 kgf): 0.6 g/10 minutes

Ethylene content of the (propylene)-(propylene-ethylene) copolymer: 6.0% by mass

Intrinsic viscosity of the (propylene)-(propylene-ethylene) copolymer ([η]Total): 2.76 dl/g

[η]II/[η]I=5.0

Polymer component (I): propylene homopolymer component

Intrinsic viscosity of polymer component (I) ([η]I): 2.75 dl/g

Polymer component (II): propylene-ethylene copolymer component

Content of polymer component (II): 16.0% by mass

Ethylene content of polymer component (II): 37.5% by mass

Intrinsic viscosity of polymer component (II) ([η]II): 2.8 dl/g

Maleic anhydride (produced by Nippon Shokubai Co., Ltd., pH: 1.2) was used as an acidic compound having a pH of higher than 0 and up to 4.

As organic peroxides, 1,3-bis(tert-butylperoxyisopropyl)benzene ((registered trademark) PERBUTYL P: produced by NOF Corporation) and dicetyl peroxydicarbonate ((registered trademark) (PERKADOX 24: produced by Kayaku Akzo Corporation) were used.

1.0 Part by mass of maleic anhydride, 0.16 parts by mass of 1,3-bis(tert-butylperoxideisopropyl)benzene, 0.54 parts by mass of dicetyl peroxydicarbonate, 0.16 parts by mass of calcium stearate, and 0.3 parts by mass of antioxidant tetrakis[methylene-3-(3,5-di-tert-butyl-4-hydroxyphenyl)propionate]methane were added to 100 parts by mass of a powder of the above-mentioned (propylene)-(propylene-ethylene) copolymer and they were preliminarily mixed well. Then, the resulting mixture was fed to a 90-mm twin screw extruder through its feeding port and kneading was carried out with the earlier stage being set to 180° C. and the latter stage being set to 250° C., and then the resultant was named modified olefin resin (C1).

(4) Olefin-Based Elastomer and/or Vinyl Aromatic Compound-Containing Elastomer (D)

### (D-1) Olefin-Based Elastomer

Ethylene-octene random copolymer (ENGAGE EG8100 (registered trademark, produced by The Dow Chemical Japan, Ltd.))

Density: 0.870 g/cm³

MFR (at 190° C. under a load of 2.16 kgf): 1 g/10 minutes

### (D-2) Olefin-Based Elastomer

Ethylene-octene random copolymer (ENGAGE EG8200 (registered trademark, produced by The Dow Chemical Japan, Ltd.))

Density: 0.870 g/cm³

MFR (at 190° C. under a load of 2.16 kgf): 5 g/10 minutes

### (5) Lubricant (E)

Erucamide (NEUTRON-S (registered trademark, [symbol] produced by Nippon Fine Chemical Co., Ltd.)

The physical properties of raw material components and resin compositions were measured in accordance with the methods shown below.

(1) Melt Flow Rate (MFR, Unit: g/10 Minutes)

Measurement was carried out in accordance with JIS K 7210 (1995) under the condition specified by a test load of 2.16 kgf and a test temperature of 230° C.

### (2) Flexural Modulus (FM, Unit: MPa)

A flexural modulus at 23° C. was measured in accordance with ASTM D790 by using a 6.4-mm thick specimen prepared by injection molding.

### (3) Elongation at Break (UE, Unit: %)

An elongation at break at 23° C. was measured in accordance with ASTM D638 by using a 3.2-mm thick specimen prepared by injection molding. The measurement was carried out at a tensile speed of 10 mm/min.

(4) Izod Impact Strength (Izod, Unit: kJ/cm²)

Measurement was carried out in accordance with the method provided in JIS-K-7110. The measurement was carried out at a measurement temperature of 23° C. by using a 3.2-mm thick, notched specimen produced by injection molding and subsequent notching.

### (5) Scratch Resistance (the Number of White Spots, Unit: Spot(s))

From the grained flat specimen described below was cut out a square flat plate sized 100 mm×100 mm, which was used for a scratch test. Using a special large-sized scratch tester manufactured by UESHIMA SEISAKUSYO CO., LTD., a damage test was carried out under the following conditions. While a load of 350 g was added to a scratch test needle tipped with a hemisphere (made of SUS403) having a diameter of 0.3 mm and forty 50-mm long scratch marks were made in both the MD and the TD at a rate of 600 mm/min, and then the number of white spots due to the scratch was counted. The fewer the white spots, the better in scratch resistance the specimen is meant to be.

### (6) pH Measurement

The pH of fillers, basic compounds, and acidic compounds was measured by the following procedures.

In a container, 20 ml of methanol was added to 5.0 g of a substance to be measured was added 20 ml of methanol, followed by stirring with a glass rod, and then 100 ml of pure water was further added. Then, the container was placed in a water bath of from 60° C. to 70° C. for 30 minutes and subsequently it was removed from the water bath and was allowed to cool to ambient temperature. Then, the cooled mixture was filtered and then the pH of the resulting filtrate was measured by the glass electrode method by using a pH meter.

### Examples 1 and 2, Comparative Examples 1 to 4

After carrying out preliminary mixing uniformly with a tumbler in the composition given in Table 1, kneading extrusion was carried out at an extrusion rate of 50 kg/hr, a cylinder preset temperature of 200° C., and a screw rotation speed of 200 rpm under vent suction by using a twin screw kneading extruder (Model TEX44αII-49BW-3V, manufactured by Japan Steel Works, Ltd.), so that a resin composition was produced.

The resulting resin composition was injection molded at a molding temperature of 220° C. and a mold temperature of 50° C. by using an IS220EN injection molding machine manufactured by Toshiba Machine Co., Ltd., whereby specimens for evaluation of flexural modulus, elongation at break, and Izod impact strength were obtained.

Moreover, injection molding was carried out at a molding temperature of 220° C. and a mold cooling temperature of 50° C. by using an SE180D injection molding machine manufactured by Sumitomo Heavy Industries, Ltd., whereby a grained flat specimen with dimensions of 400 mm×100 mm×3 mm for scratch resistance evaluation was obtained.

Physical properties of the resulting resin composition are shown in the following Table 2. In the table, the contents of the component (A) and the component (B) are values taken where the sum total thereof shall be 100% by mass, and the contents of the component (C1), the component (D), and the component (E) are values taken where the sum total of the component (A) and the component (B) shall be 100 parts by mass.

TABLE 1

| | A | | B | | | | C1 (part(s) | D (part(s) | | E (part(s) |
|---|---|---|---|---|---|---|---|---|---|---|
| | (% by mass) | | (% by mass) | | | | by mass) | by mass) | | by mass) |
| | A-1 | A-2 | B-1 | B-2 | B-3 | B-4 | C1 | D-1 | D-2 | E-1 |
| Example 1 | 74.1 | 12.3 | 3.7 | 9.9 | — | — | 0.6 | 11.7 | 11.7 | 0.4 |
| Example 2 | 74.1 | 12.3 | 7.4 | 6.2 | — | — | 0.6 | 11.7 | 11.7 | 0.4 |
| Comparative | 74.1 | 12.3 | — | 13.6 | — | — | 0.6 | 11.7 | 11.7 | 0.4 |
| Example 1 | | | | | | | | | | |
| Comparative | 74.1 | 12.3 | — | 6.2 | 7.4 | — | 0.6 | 11.7 | 11.7 | 0.4 |
| Example 2 | | | | | | | | | | |
| Comparative | 74.1 | 12.3 | — | 6.2 | — | 7.4 | 0.6 | 11.7 | 11.7 | 0.4 |
| Example 3 | | | | | | | | | | |
| Comparative | 74.1 | 12.3 | -— | 6.2 | — | 7.4 | — | 11.7 | 11.7 | 0.4 |
| Example 4 | | | | | | | | | | |

TABLE 2

| | | | | | The number of |
|---|---|---|---|---|---|
| | MFR | FM | UE | IZOD | white spots |
| Example 1 | 29.6 | 1380 | 478 | 54 | 2 |
| Example 2 | 30.1 | 1400 | 419 | 48 | 4 |
| Comparative | 31.3 | 1490 | 269 | 26 | 32 |
| Example 1 | | | | | |
| Comparative | 31.9 | 1400 | 285 | 33 | 16 |
| Example 2 | | | | | |
| Comparative | 32.8 | 1510 | 174 | 39 | 100 |
| Example 3 | | | | | |
| Comparative | 31.8 | 1510 | 194 | 47 | >200 |
| Example 4 | | | | | |

1. A propylene resin composition comprising:
from 60% by mass to 99% by mass of a propylene resin (A),
from 1% by mass to 40% by mass of a filler (B1) having a pH of from 9 to 14, where the sum total of the contents of the propylene resin (A) and the filler (B1) shall be 100% by mass, and
from 0.01 parts by mass to 5 parts by mass, relative to 100 parts by mass of the propylene resin (A) and the filler (B1) in total, of a modified olefin resin (C1) defined below:
the modified olefin resin (C1) is a resin obtained by reacting 100 parts by mass of an olefin resin, from 0.01 parts by mass to 20 parts by mass, relative to 100 parts by mass of the olefin resin, of an acidic compound having at least one unsaturated bond and at least one kind of polar group and having a pH of higher than 0 and up to 4, and from 0.001 parts by mass to 20 parts by mass of an organic peroxide.

2. A propylene resin composition comprising:
from 60% by mass to 99% by mass of a propylene resin (A),
from 1% by mass to 40% by mass of a filler (B2) having a pH of higher than 0 and up to 4, where the sum total of the contents of the propylene resin (A) and the filler (B2) shall be 100% by mass, and
from 0.01 parts by mass to 5 parts by mass, relative to 100 parts by mass of the propylene resin (A) and the filler (B2) in total, of a modified olefin resin (C2) defined below:
the modified olefin resin (C2) is a resin obtained by reacting 100 parts by mass of an olefin resin, from 0.01 parts by mass to 20 parts by mass, relative to 100 parts by mass of the olefin resin, of a basic compound having at least one unsaturated bond and at least one kind of polar group and having a pH of from 9 to 14, and from 0.001 parts by mass to 20 parts by mass of an organic peroxide.

3. The propylene resin composition according to claim 1, wherein the acidic compound is any one compound selected from the group consisting of maleic anhydride, maleic acid, and fumaric acid.

4. The propylene resin composition according to claim 2, wherein the basic compound is any one compound selected from the group consisting of N-methylaminoethyl (meth)acrylate, N-ethylaminoethyl (meth)acrylate, N,N-dimethylaminoethyl (meth)acrylate, and a quaternary ammonium salt of N,N-dimethylaminoethyl (meth)acrylate.

5. The propylene resin composition according to claim 1, further comprising from 1 part by mass to 40 parts by mass, relative to 100 parts by mass of the propylene resin (A) and the filler (B1) in total, of an olefin-based elastomer and/or a vinyl aromatic compound-containing elastomer (D).

6. The propylene resin composition according to claim 1, further comprising from 0.01 parts by mass to 5 parts by mass, relative to 100 parts by mass of the propylene resin (A) and the filler (B1), of a lubricant (E).

7. The propylene resin composition according to claim 2, further comprising from 1 part by mass to 40 parts by mass, relative to 100 parts by mass of the propylene resin (A) and the filler (B2) in total, of an olefin-based elastomer and/or a vinyl aromatic compound-containing elastomer (D).

8. The propylene resin composition according to claim 2, further comprising from 0.01 parts by mass to 5 parts by mass, relative to 100 parts by mass of the propylene resin (A) and the filler (B2), of a lubricant (E).

9. The propylene resin composition according to claim 3, further comprising from 1 part by mass to 40 parts by mass, relative to 100 parts by mass of the propylene resin (A) and the filler (B1) in total, of an olefin-based elastomer and/or a vinyl aromatic compound-containing elastomer (D).

10. The propylene resin composition according to claim 3, further comprising from 0.01 parts by mass to 5 parts by mass, relative to 100 parts by mass of the propylene resin (A) and the filler (B1), of a lubricant (E).

11. The propylene resin composition according to claim 5, further comprising from 0.01 parts by mass to 5 parts by mass, relative to 100 parts by mass of the propylene resin (A) and the filler (B1), of a lubricant (E).

12. The propylene resin composition according to claim 4, further comprising from 1 part by mass to 40 parts by mass, relative to 100 parts by mass of the propylene resin (A) and the filler (B2) in total, of an olefin-based elastomer and/or a vinyl aromatic compound-containing elastomer (D).

13. The propylene resin composition according to claim 4, further comprising from 0.01 parts by mass to 5 parts by mass, relative to 100 parts by mass of the propylene resin (A) and the filler (B2), of a lubricant (E).

14. The propylene resin composition according to claim 7, further comprising from 0.01 parts by mass to 5 parts by mass, relative to 100 parts by mass of the propylene resin (A) and the filler (B2), of a lubricant (E).

15. The propylene resin composition according to claim 12, further comprising from 0.01 parts by mass to 5 parts by mass, relative to 100 parts by mass of the propylene resin (A) and the filler (B2), of a lubricant (E).
